(19) United States
(12) Patent Application Publication
(10) Pub. No.: US 2025/0154807 A1
(43) Pub. Date: May 15, 2025

(54) SAFETY DEVICE FOR GARAGE DOORS

(71) Applicant: Francisco Hernandez Ruiz, Mexicali (MX)

(72) Inventor: Francisco Hernandez Ruiz, Mexicali (MX)

(21) Appl. No.: 18/937,996

(22) Filed: Nov. 5, 2024

(30) Foreign Application Priority Data
Nov. 10, 2023 (MX) MX/U/2023/000478

(51) Int. Cl. E05C 19/18

(52) U.S. Cl. CPC E05C 19/188

(57) ABSTRACT

A safety device for garage doors that is placed on a trolley that is part of the door opener mechanism, whose function is to engage and guide the movement of the garage door according to the activation of the motor of said mechanism. The trolley usually has an emergency trigger that can be activated in the event of an accident or an engine malfunction. However, it is also prone to being activated by outsiders from outside the home where the door opener mechanism is installed, freeing the door from its coupling with the motor, allowing unauthorized opening. The purpose of the device is to cover the trolley through a housing and prevent activation by outsiders, while maintaining access to the trigger for authorized persons through a simple and easy to place structure, which allows the device to be attached to the trolley by means of flexible flanges and magnetic elements, unlike other device configurations that require screws or additional elements to the housing.

### FIELD AND OBJECT OF THE INVENTION

The invention presented in this specification belongs to the field of mechanics. Particularly to a security device for garage doors. Specifically, to a device intended for locking a door opener mechanism by means of a cover that prevents its manipulation by external means, which can be used in a plurality of applications, among them, as an anti-theft device for garage doors.

### BACKGROUND

Today, the automation of daily activities increases over time through various applications. This document refers to garage doors and the mechanical devices that allow and automate their opening. A conventional door opener mechanism works by supplying electrical power to a motor coupled to the garage door by means of a trolley mounted on a rail that directs its movement. The trolley usually consists of an assembly of metal sheets whose walls take the shape of the rail and surround it, so that the trolley coupled to the motor by means of a chain (or other means, depending on the model of the door opening mechanism) moves along the rail according to the movement dictated by the motor, by opening or closing the garage door to which it is attached as it moves along the rail.

In the event that the door opener mechanism does not have an electrical power supply, the garage door can be operated and opened or closed manually by means of an emergency trigger that releases the trolley attached to the door. The manual release mechanism of the emergency trigger is designed as a safety measure to allow the disconnection of the trolley from the attachment with the electric motor, where the trigger is usually small in size and which, coupled to the trolley, is not reachable by a person of average height. To do this, the trigger has a long rope attached to it that allows it to be pulled, pulling the trigger and releasing the trolley. However, this system presents a significant vulnerability.

The problem is that devices of this type can be tampered with in an unauthorized manner and activate the emergency trigger intentionally or accidentally. This allows the garage door to be opened or closed without the need for access control and consequently there is a vulnerability and the possibility of unauthorized personnel accessing the interior of the property, presenting a security problem that the door opener mechanism itself aims to avoid and creating a contradiction in terms of the operation of the device.

In particular, the security breach is that the emergency trigger can be pulled from outside the property with an object that reaches the trigger. For example, a commonly used technique involves pulling the trigger with a hook-type object, for example, a wire hook to hang shirts or pants, where the wire is extended leaving the hook shape at one end and it is inserted between the groove formed between the door and the wall that supports it, obtaining the necessary length and hook from outside the garage to reach and activate the trigger, opening the door from the outside. Because of this, there is a need to solve the security problem applied to garage doors so that the emergency trigger that releases the trolley is not manipulated by unauthorized personnel and to guarantee the safety of the owner.

Part of the solutions to the problem presented in previous paragraphs consists of the use of devices in addition to the mechanism that controls the movement of the trolley where the emergency trigger is located. Such devices provide a cover to the trigger and by their design allow only the rope attached to the trigger to protrude from said cover to be operated only by a person who is inside the garage, while blocking any manipulation of the trigger with objects from outside the door, in such a way that unauthorized access is not possible and devices such as the hook example above are useless because they do not have sufficient grip to pull the rope.

When using this type of cover, it is not necessary to replace the door opener mechanism, only the installation of the attachment that provides the security reinforcement for garage doors is required. Similarly, there are different systems that provide security for garage doors, among them are pin locks, the use of alarms and intrusion sensors, door reinforcement devices against attempted struggles, the use of access control systems through cards or codes. In each case, the same objective is achieved, to provide greater security to prevent unauthorized persons from accessing the property through the garage door. However, the use of cover-type devices provides the desired security in a simple way compared to the different methods mentioned above.

Taking into account the problems presented above, the state of the art presents various solutions, some of which are described below:

USD667036 design document describes a cover for the motor of a roof door opener in which it is identified that the way it is fastened is by means of screws or pins.

On the other hand, the document CN2011200729259U describes an anti-theft structure for a door that prevents the lock from being manipulated from the outside characterized by having a lock that provides anti-theft properties.

Similarly, FR9900071 document presents a garage door lock that has a magnetic brake at the end of a sheet fixed to the closing housing, where the magnet is in permanent contact with a bolt.

U.S. Pat. No. 17,518,217 document provides a motorized opener garage door system to control its movement that has magnets configured to engage the door in the closed position and release them when opened.

U.S. Pat. No. 15,649,091 registration invention features a garage door locking system with an actuator lock box to be integrated into existing door openers mechanisms that provides a sequential locking or unlocking function that has the possibility of being activated magnetically.

On the other hand, the invention CN2009100074837A consists of an anti-theft system for doors with electromagnetic opening in the event of power outage and has an unlocking theft. In the event of a power outage, a key turns a locking core and releases the door by means of magnets that are disengaged.

Finally, the DE19732201 document consists of a garage door lock with magnetic key and burglary alarm system, where the lock housing contains an electromagnet that moves a bolt and allows opening.

The current state of the art shows different alternatives to achieve anti-theft security in garage doors. The inventions presented earlier in this section of the paper only indicate some of the ways in which security measures in garage doors can be improved and, in some of the cases, these are security systems dedicated to protection with different components or equipment apart from the door opener motor, making them complex systems.

Despite the above, the emergency trigger mechanism in the door opener motor continues to represent a breach that can be manipulated to obtain unauthorized access to the property through the garage door. In the case of the inventions presented that describe the use of covers to prevent external manipulation by means of emergency trigger locking, these represent an improvement in simplicity in functionality, but they still depend on other components and elements for them to meet the objective, such as fasteners that allow them to be attached to the trolley or other parts of the opening mechanism.

The invention proposed in this specification integrates magnetic fastening means, increasing the simplicity of installation since it only requires that the device be located and positioned, being fixed by means of magnets, maintaining the security required to solve the problem. Other than diverse and complex safety systems with magnetic or electromagnetic elements applied to other parts of the opening mechanism, no evidence was found in published documents to show that a cover safety device for these types of door opener mechanisms can be fixed by magnetic means, such as the one described below.

### SUMMARY

In garage doors that work electrically, they are operated remotely with a device or remote control for their opening and closing. The door opener motor requires an electrical power supply in order for it to operate, but in the event of no electrical power or a malfunction situation, the opening mechanism is designed to be manipulated and released by activating an emergency trigger on the trolley that engages the electric motor with the door, allowing it to be opened or closed.

The incorporation of the emergency trigger is designed for exclusive use from inside the property. However, the trigger can be reached from the outside by unauthorized persons and, when activated, the motor mechanism is released allowing access, which is undesirable.

The invention described here comprises a garage safety device which consists of a housing, preferably essentially parallelepiped, hollow and open. The housing features two side walls joined by a bottom base with an opening and a back wall. In addition, two flanges are attached at the top of the sidewalls each, where at least one magnetic element is located on the inside of each flange. The housing is mounted on the trolley of the door opener mechanism, so that the emergency trigger attached to the trolley is covered. The housing is attached to the trolley by means of the magnetic elements in the flanges, which are flexible to adjust their opening according to the shape and dimensions of the trolley of the door opener mechanism. The opening at the lower base of the housing allows the passage of a rope attached to the emergency trigger so that the latter can be operated by pulling the rope from inside the garage even with the safety device installed on the trolley, while the trigger remains hidden inside the housing and cannot be operated by people from outside the garage.

Thus, the safety device for garage doors proposed in this description blocks access to the emergency trigger from the outside, achieving the objective of preventing the unauthorized activation of the garage door opening mechanism. In addition, the device has magnetic fastening means, which provide ease of installation since it is only necessary to place the housing on the opening mechanism trolley and the built-in magnets hold it in position, which simplifies its use compared to other inventions.

As described above, the use of the proposed safety device for garage doors has advantages compared to inventions that have the same objective, and can also be applied in any door opener mechanism that has a trolley with an emergency trigger, providing a solution to the user to the security problem in a simple and effective way.

### BRIEF DESCRIPTION OF THE FIGS.

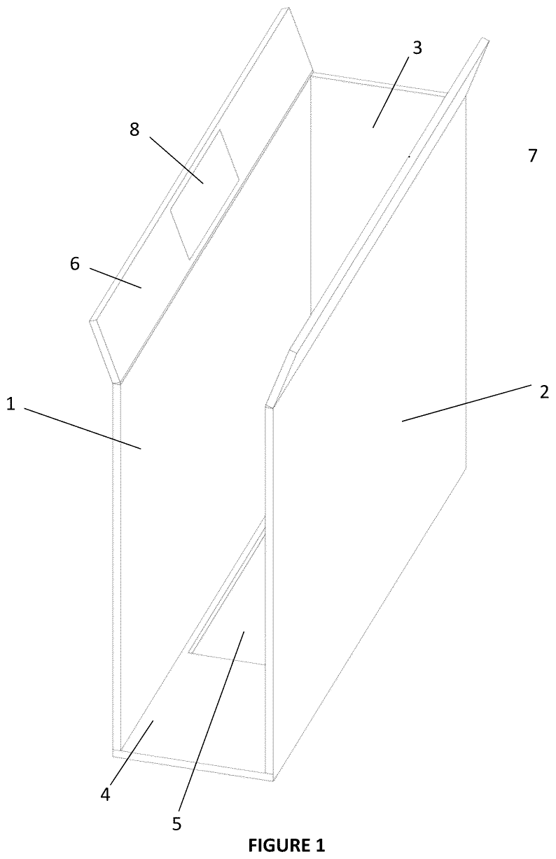

FIG. 1.—Top isometric view of the safety device for garage doors.

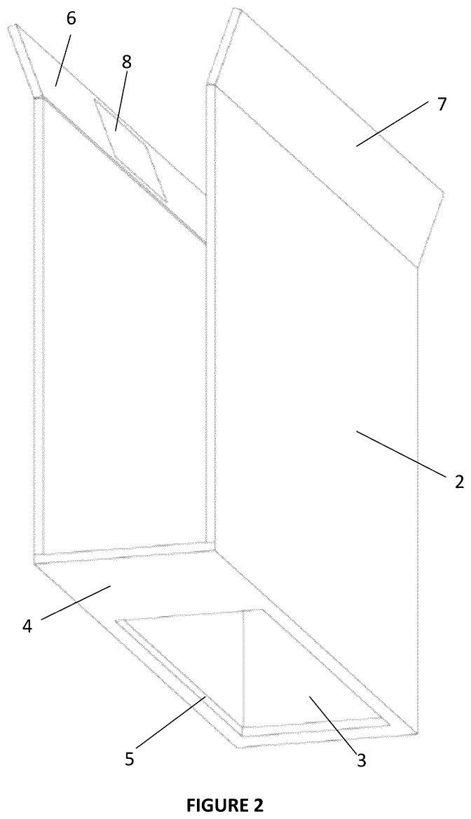

FIG. 2.—Lower isometric view of the safety device for garage doors.

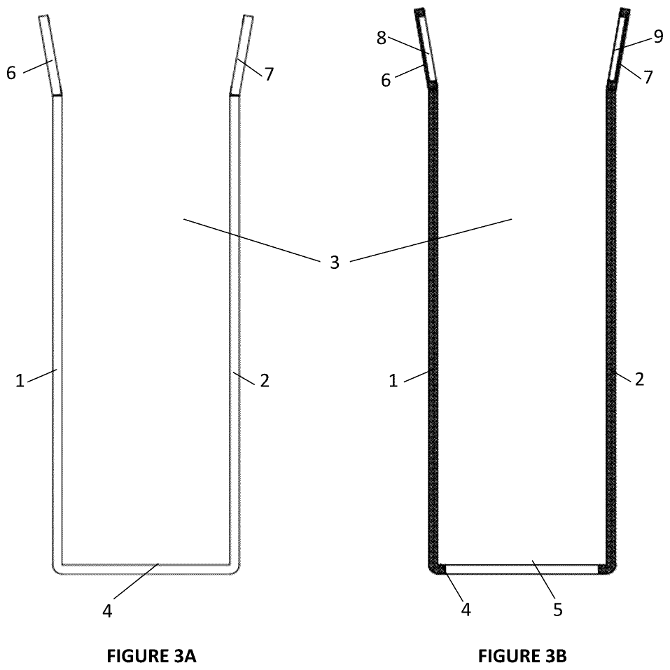

FIG. 3A—Rear view of the safety device for garage doors.

FIG. 3B—Rear view with cross-section and detail of the opening at the bottom base and a preferential location of the magnetic elements on the flanges of the safety device for garage doors.

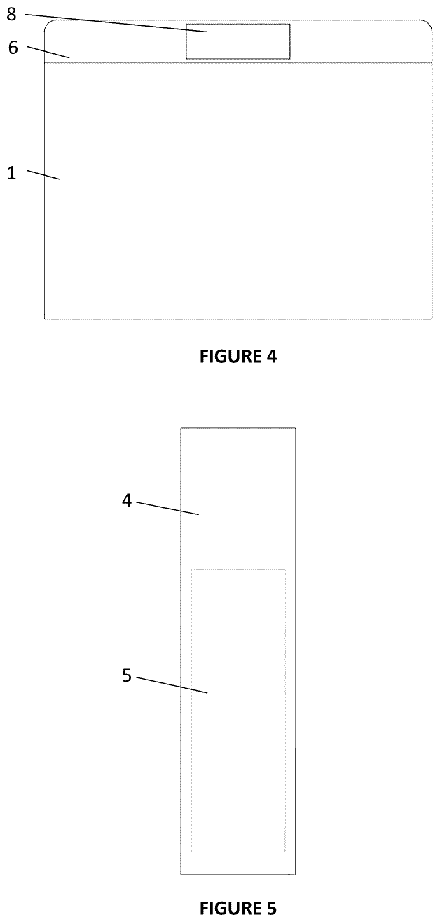

FIG. 4.—Side view of the garage security device, indicating a preferential location of the magnetic element in a flange.

FIG. 5.—Bottom view of the security device for garage doors.

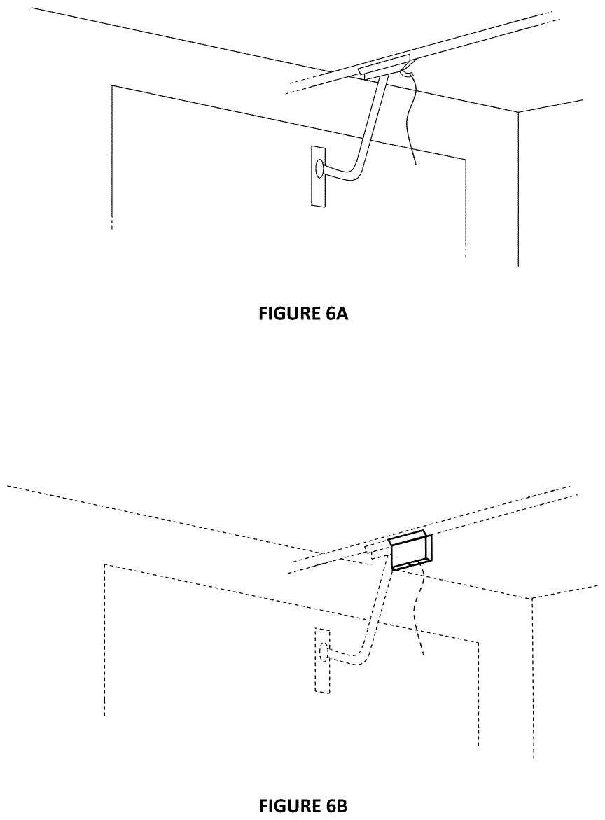

FIG. 6A.—Isometric view from inside an installation of an opening mechanism for garage doors.

FIG. 6B.—Isometric view from inside an installation of a garage door opening mechanism, with the safety device for garage doors placed on the trolley, protecting the emergency trigger without preventing its activation for people.

### DETAILED DESCRIPTION OF THE INVENTION

The invention proposed herein consists of a safety device for garage doors by using a housing to cover the trolley and its emergency trigger attached to the door of the door opener mechanism. The purpose of the invention is to prevent external tampering with the emergency trigger from outside the garage door by unauthorized personnel. The housing of the safety device is designed to present itself as a barrier between the emergency trigger and any tampering attempt from outside the property while also allowing it to be activated from within the property according to the original design of the device.

Fundamentally, the invention comprises a single piece which is placed on the trolley of the door opener mechanism and its emergency trigger. The piece includes a housing whose shape and size allows to cover the structure of the trolley and the emergency trigger of the door opener mechanism. The description given below is detailed around a form of parallelepiped, without this limiting other geometries that can be used within the scope of the invention and to achieve the proposed objective.

The device housing comprises two side walls (1, 2) joined by a front wall (3) and a bottom base (4) with an opening (5). The height and width of the walls and base are of an appropriate size to cover the trolley and the emergency trigger of the door opener mechanism in which the safety device is installed.

Each side wall (1, 2) has a flange (6, 7) attached lengthwise to its upper edge. The joint between each wall and its corresponding flange is flexible, allowing the flange to rotate around this longitudinal junction, being able to adjust its opening with respect to the housing. The flanges (6, 7) are the means of contact between the housing of the safety device and the trolley of the door opener mechanism. In this way, the opening of the flanges (6, 7) adjusts to the shape and inclination of the walls of the trolley, so that the flanges have as much contact as possible with the walls of the trolley and achieve fastening.

There are several ways to achieve a flexible bond between each wall and its corresponding flange, which will be described in detail below. Preliminarily, it is clarified that it is possible for the walls and flanges to be manufactured in a single piece from a flexible material, such as resin or plastics known in the state of the art.

At least one magnetic element (8, 9) is attached to each flange (6, 7), allowing the flange to be attached to the metal structure of the trolley and the device housing to maintain its fixed position covering the bottom of the trolley and its emergency trigger. Magnetic elements can be natural or artificial magnets, e.g. induced magnets.

Below is a detailed description of how to make use of the invention in order to show how the objective of increasing security in garage doors is fulfilled.

The user with a garage door brings the device closer to the trolley, with the flanges (6, 7) open, from the bottom of the trolley of the opening mechanism. By shortening the distance, magnetic elements (8, 9) of the flanges are attracted to the trolley, usually metallic, by rotating the flanges around their longitudinal junction with the side walls, aligning and closing them to come into direct contact with the surface of the trolley. When attached to the trolley, the housing of the safety device completely covers its lower part, including the emergency hook that is attached to the trolley, leaving space through the lower opening (5) to allow the passage of the rope that is normally attached to the emergency hook for activation if necessary, only from a position where the user is placed under the trolley to pull said rope. In this way, the emergency hook is out of the reach of any other person or means that intends to activate it from a position outside the garage.

The security device for garage doors proposed in this description allows the implementation of an additional anti-theft security measure while providing a solution that is implemented in an intuitive, effective and simple way, since the location and fixing of the housing to the door opener mechanism does not require additional tools, being limited only to the novel and typical characteristics of the device already described.

### PREFERRED EMBODIMENTS OF THE INVENTION

To obtain anti-theft security in garage doors by using a housing that covers the door opener motor, it is preferable to take into account certain parameters and considerations, for example, when selecting the material of the housing or the number and position of the magnetic elements that hold it.

Below, some of the parameters to be considered are specified, including but not limited to, and the values thereof that have served to achieve the result proposed by the present invention. It should be clarified that the inclusion of the following information does not limit the modification of parameters included or not included in this description, and that any modification and/or combination of one or more of these parameters must be considered as a modality of this invention. Likewise, the combination of one or more of the following preferred embodiments must be considered within the potential scope of the invention disclosed herein.

In a first preferred embodiment of the invention, the housing of the garage security device is made of stainless steel, which ensures its rigidity and impenetrability with common tools used by third parties to gain unauthorized access to other people's properties.

In another preferred embodiment of the invention, the housing of the garage security device is made of flexible plastic, where in addition to providing rigidity and impenetrability, a safety device of a lower weight than others existing on the market made from metallic materials is obtained.

In another preferred embodiment of invention, the housing of the safety device has a hollow parallelepiped shape, i.e. with a rectangular transverse profile with straight edges at all ends.

In another preferred embodiment of invention, the housing of the safety device has a rounded shape, where the side walls, the front wall and the base are convex outwards.

In another preferred embodiment of the invention, the flanges (6, 7) attached to the side walls have protruding extensions at an angle perpendicular inwards (not illustrated), so that they generate claw-shaped edges to reinforce the fastening of the housing to the door opener mechanism trolley.

In another preferred embodiment of the invention, the joints of the flanges (6, 7) to the upper edges of the side walls are elastic, which allows the flanges to be opened beyond the opening of the manufacturing design of the housing to conform to dimensions of a trolley larger than the standard dimensions, and then closed on the trolley, seeking to return to the original design opening.

In another preferred embodiment of invention, the joints of the flanges to the upper edges of the side walls comprise at least one hinge each (not illustrated). The hinge allows the opening of the flaps to be adjusted according to the size of the trolley of the opening mechanism where the safety device is installed. Hinges can be of any type, for example and without limitation: bolt, cup, book, among others.

In another preferred embodiment of invention, magnetic elements (8, 9) are located in the center of each flange.

In another preferred embodiment of the invention, a plurality of magnetic elements are distributed along the flange, so that the fastening of said flanges to the surfaces of the carriage of the opening mechanism is strengthened.

In another preferred embodiment of the invention, the position of the magnetic elements on each flange is adjustable and can be slid to allow a customization of its position according to the user needs.

In summary, the preferred embodiments described above demonstrate the versatility and potential of the garage door security device to prevent opening by unauthorized personnel. The use of this security device is simple compared to other proposals in the state of the art, obtaining anti-theft security in garage door systems efficiently and with a design applicable to practically any door opening mechanism.

1. Safety device for garage doors of the type comprising a housing with a base and walls to protect an emergency trigger from an opening mechanism, where the base of the housing includes an opening, characterized by also comprising at least:
a flange attached to the top edge of each wall, where the joint is flexible allowing the flange to rotate around the joint and adjust its opening with respect to the housing; and
a magnetic element attached to each flange.

2. Safety device for garage doors according to claim 1, characterized in that its shape is a hollow parallelepiped with two side walls joined by means of the base and a front wall, where each side wall has a flange with a magnetic element.

3. Safety device for garage doors according to claim 1, characterized in that the flexible connection between each flange and each wall is a longitudinal joint.

4. Safety device for garage doors according to claim 1, characterized in that the housing is made of rigid and impenetrable stainless steel.

5. Safety device for garage doors according to claim 1, characterized in that the housing is made of flexible plastic.

6. Safety device for garage doors according to claim 1, characterized in that the housing has a rounded shape with a base and rounded walls convex outwards.

7. Safety device for garage doors according to claim 1, characterized in that the flanges include protruding extensions at perpendicular angles that form claw-shaped edges.

8. Safety device for garage doors according to claim 1, characterized in that the joints between each flange and each wall are elastic joints that allow each flange to be opened beyond the design opening and returned to the original opening.

9. Safety device for garage doors according to claim 1, characterized in that the joints between each flange and each wall are made by means of a hinge.

10. Safety device for garage doors according to claim 1, characterized in that the magnetic element of each flange is located in the center of each flange.

11. Safety device for garage doors according to claim 1, characterized by a plurality of magnetic elements being distributed along each flange.

12. Safety device for garage doors according to claim 1, characterized in that the position of each magnetic element is adjustable and can be slid to change position.
